(19) United States
(12) Patent Application Publication
(10) Pub. No.: US 2007/0057778 A1
(43) Pub. Date: Mar. 15, 2007

(54) Alarm combining audio signaling and switch functions

(75) Inventors: Frank Andrew Prince JR., Lewis Center, OH (US); Raymond W. Hunter, Powell, OH (US)

Correspondence Address: KREMBLAS, FOSTER, PHILLIPS & POLLICK, 7632 SLATE RIDGE BOULEVARD, REYNOLDSBURG, OH, 43068, US

(73) Assignee: Floyd Bell, Inc.

(21) Appl. No.: 11/226,166

(22) Filed: Sep. 14, 2005

(51) Int. Cl. G08B 3/10

(52) U.S. Cl. 340/384.6

(57) ABSTRACT

A switch function is incorporated into an audible alarm by sensing obstruction of a sound emitting orifice opening into the chamber of an acoustic impedance matching network of the alarm. The alarm has an electromechanical sound transducer in acoustic communication with the chamber and an electronic drive circuit for driving the transducer. The circuit senses a change beyond a selected threshold of the sound pressure wave in the chamber caused by the obstruction. Some means by which the sound pressure change can be sensed are by sensing voltage, current or phase changes of the impedance of the transducer or by directly sensing the sound pressure wave by a microphone or the use of a third terminal on a piezoelectric transducer. The invention can also be used with acoustic frequencies outside the range of frequencies that are perceivable by human hearing and can be used as a proximity switch that switches in response to an obstruction or a gas or fluid stream.

### (e) BACKGROUND OF THE INVENTION

1. Field of the Invention

This invention relates generally to audible alarm devices and more specifically to the combination, within a single body in a compatible manner, of both an audible alarm device and a switch function to control the operation of the audible alarm and/or for other switching functions.

2. Description of the Related Art

From ancient times audible alarms such as bells and gongs have signaled alarm conditions. Many present types of equipment incorporate audible alarms in the form of speakers, buzzers, and particularly piezoelectric elements. The piezoelectric alarms are typical of such alarms and will be described in more detail.

Piezoelectric audible alarms have been used since the 1960's as evidenced by U.S. Pat. Nos. 2,983,903 and 3,421,109. Audible alarms are known in the prior art that are made with a transducer, such as a piezoelectric bender, that induces sound pressure waves in an acoustic impedance matching network that includes a chamber having an orifice through which the sound is emitted to the ambient atmosphere. The transducer is commonly driven by a drive circuit that applies pulse width modulated pulses to the transducer. The period between the pulses determines the frequency. The duty cycle determines the power and the amplitude of the sound pressure wave. For a given period, the duty cycle is proportional to the pulse width. A pulse width modulator with a controllable frequency or a controllable pulse width or both has been used for such alarms.

The alarm performs the function of alerting the audience of an alarm condition. Once the audience is alerted, an alarm ceases to be useful and can become a distraction to those servicing the alarm condition. The continuing operation of the alarm can also mask subsequent alarm conditions. Therefore, it is often desirable to reduce the sound intensity of or entirely disable the alarm so that the sound ceases. Additionally or alternatively, it is sometimes desirable to initiate or disable some other activity related to the alarm condition that was signaled. Consequently, a switch function is desirable in an ordinary two-terminal alarm to allow the operator to mute or reduce the alarm output sound after the alarm condition is recognized and acknowledged by an operator who is a member of the audience.

Many sophisticated operations incorporating an alarm include an acknowledgment function to allow an operator to indicate that the alarm condition is recognized and that the alarm indicators can be muted or turned off. Where the alarm is not part of a sophisticated system, the acknowledge function can only be accomplished by additional circuitry including switching and latching functions. The lack of a means of quieting or muting an audible alarm once the condition has been recognized has often resulted in operators damaging or disabling the alarm in order to still the sound. This has led to the subsequent unavailability of the alarm which can create dangerous unrecognized alarm conditions.

Therefore, it is often desirable to provide a way for an alarm to sense that an operator has become aware of the alarm condition so that the operator can easily and intuitively reduce or disable the alarm sound intensity. It is particularly desirable to include the sensing and sound reduction functions as a part of the alarm in a way that requires very little additional circuitry.

Although a switch can theoretically be mounted to an alarm and connected to circuitry for reducing the alarm sound intensity, that solution is impractical for small alarms that are packaged in small cases. A switch mounted to such an alarm and the wires that lead to it would interfere with the integrity of the sound chamber and thus interfere with its acoustic properties, expose the alarm to destructive ambient materials and cause substantial additional production cost. Additionally, a switch would have to be switched again before the reactivation of the alarm so that the alarm is ready to alert at full volume the next alarm condition.

There is, therefore, a need for an audible alarm that allows an operator to intuitively and easily acknowledge the alarm without requiring an additional acknowledgement switch and without requiring additional hardware or circuit elements that would occupy a substantial volume of space or interfere with the sound generating efficiency of the alarm.

There is also a need to provide a device that is able to detect an obstruction of the sound path and consequently can be used as a switch or proximity detector. Such a switching function is particularly useful when the obstruction is not visible, such as is the case with a column of fast-moving gas or fluid.

### (f) BRIEF SUMMARY OF THE INVENTION

This invention consists of a method and apparatus for allowing a manufacturable module incorporating both an audible alarm together with an integrated switching function to allow detection of a complete or partial obstruction of the path of the emitted sound. This obstruction of the sound path may be used to enable the quieting or muting of the alarm and/or to initiate other action. The quieting of the alarm is often desirable in response to operator acknowledgement of the alarm by partially or completely obstructing the sound emission path from the audible device. A partial obstruction of the sound emission path from the audible device can include the presence of a body in the sound path near the orifice without contact with the orifice. This obstruction of the sound path is detected within the audible device by incorporating into the alarm module a sensing circuit for detecting a change in the sound pressure wave within the audible device. The two preferred ways of detecting the sound pressure wave and its changes are by sensing changes in the sound transducer drive caused by obstruction of the orifice or by directly sensing the sound pressure waves in the chamber, as by means of a microphone or a voltage on a piezoelectric element. Preferably, a change in the sound transducer drive is sensed by sensing a change in the voltage across or the current through the sound transducer beyond a selected threshold. The change is sensed during audible output in order to detect the operator's obstruction of the sound path for use as an indication that the alarm has been acknowledged by that operator and should be reduced in intensity or turned off and/or other activities initiated or disabled.

### (g) BRIEF DESCRIPTION OF THE SEVERAL VIEWS OF THE DRAWINGS

FIG. 1 is a view in section showing the construction of a typical, prior art piezoelectric audible alarm.

FIG. 2 is a block diagram illustrating a drive circuit for a typical piezoelectric audible alarm with the addition of a sensing circuit in accordance with the present invention.

FIG. 3 shows oscillograms of the drive voltage to a switch across the piezoelectric crystal in a piezoelectric drive circuit and the resulting voltage across the piezoelectric crystal showing normal operation in solid lines and the change during operation when the audible alarm orifice is blocked in dashed lines.

FIG. 4 is a block diagram illustrating an alternative embodiment of the invention using a third terminal on a piezoelectric transducer.

FIG. 5 is a block diagram illustrating another alternative embodiment of the invention using a microphone to sense changes resulting from obstruction of the alarm orifice.

FIG. 6 is a perspective and diagrammatic view illustrating a human finger obstructing an orifice to actuate the switching function of the invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto is often used. They are not limited to direct connection, but include connection through other circuit elements where such connection is recognized as being equivalent by those skilled in the art. In addition, many circuits are illustrated which are of a type which perform well known operations on electronic signals. Those skilled in the art will recognize that there are many, and in the future may be additional, alternative circuits which are recognized as equivalent because they provide the same operations on the signals.

### (h) DETAILED DESCRIPTION OF THE INVENTION

This invention involves sound waves and the description utilizes such terms as “sound”, “acoustic” and “audible” all relating to sound pressure waves. Such waves are known to be alternating compressions and rarefactions radiating from a source through a physical medium or mass. Although these terms are often defined as referring to pressure waves within a frequency range that can be perceived by the human ear, it is also known that such waves also occur, and have many uses, at the lower subsonic or infrasonic frequencies and at the higher ultrasonic frequencies. Although the principal utility of the present invention is believed to be with frequencies within the range of human perception, the principles of the invention are also applicable to subsonic and ultrasonic frequencies. Therefore, these terms are used in the broader sense of such waves in a medium at any of these frequencies.

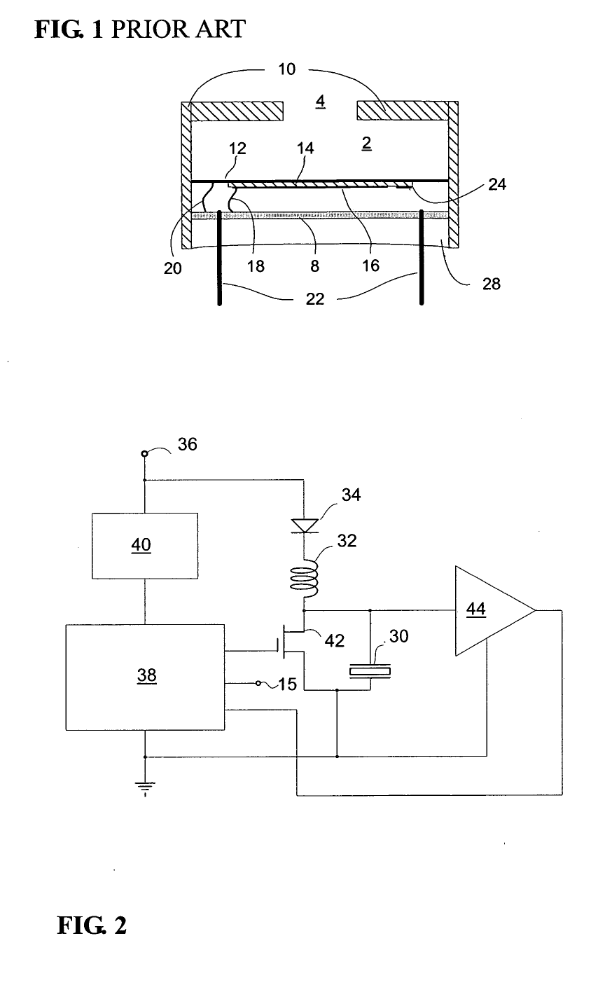

FIG. 1 represents an implementation of a piezoelectric alarm as known in the prior art. A piezoelectric bender consists of a metal disk 12 supporting an attached piezoelectric element 14 with a top electrode 16. The metal disk 12 vibrates in response to an alternating electric field applied between the disk 12 and electrode 16. This bender is mounted in an enclosure 10 which forms a Helmholtz cavity 2 with the bender disk 12. This Helmholtz cavity is sized to resonate at the mechanical resonant frequency of the bender in order to efficiently generate sound for transmission through the cavity orifice 4. The Helmholtz cavity 2 is an acoustic impedance matching network that is a chamber in the form of the cavity 2 to provide efficient energy transfer between the small excursions of the piezoelectric bender and the movement of the air in a sound wave.

Other acoustic impedance matching networks may be used for the impedance matching function. As well known in the art, the efficiency of energy transfer from a source to a load is maximized when the input impedance of the load matches the output impedance of the source. Consequently, the purpose of the acoustic impedance matching network is to maximize the energy coupled from the transducer to the cavity. One example of another acoustic impedance matching network is a folded horn, which may alternatively be used for the impedance matching in an alarm. The folded horn operates somewhat like a trumpet. It is a long, narrow chamber that is looped around and has an orifice at one end and a transducer at its opposite end. The term chamber is meant to include any portion of the sound path within the acoustic impedance matching network

In order to provide the electrical field across the piezoelectric element 14, a circuit board 8 containing the drive electronics is connected to the bender disk 12 through lead 20, and to electrode 16 through lead 18. Power and sometimes control is provided to the circuit board 8 through two or more external electrodes 22. In order to provide structural strength and protect the electronic components, the back of enclosure 10 is often potted within the space 28.

Because the Helmholtz cavity 2 is exposed to the ambient atmosphere through the cavity orifice 4, the interface between the enclosure 10 and the bender disk 14 is often sealed by ultrasonic welding or by application of a sealant. It is therefore important to maintain the structural integrity of the resonant cavity 2 in order to prevent the passage of moisture or other atmospheric borne substances beyond the disk 14 where they can contact and deteriorate the circuit elements. The need for this structural integrity limits the practical application of a switch mounted adjacent to the orifice in a normal alarm configuration as described above.

When an audible alarm, such as illustrated in FIG. 1, is operating normally, a sound transducer, such as a speaker or a piezoelectric bender, is exciting an acoustic impedance matching system that includes a chamber, such as a Helmholtz cavity or folded horn structure, resulting in the creation of audible sound. This sound can exit from the audio alarm from one or more orifices and represents the conversion of electrical energy applied to the transducer to the energy of the sound waves transmitted from the orifice into the ambient air. If the orifice or orifices are blocked, the transmission of sound energy through the orifice and out of the cavity is blocked and the sound energy is reflected back to the transducer. This in turn substantially changes the sound energy coupled from the transducer to the chamber of the acoustic impedance matching network by, for example, creating standing waves of sound pressure. These results occur not only when the orifice is blocked or completely obstructed, but also occur for a partial obstruction, such as when an obstruction is approaching the orifice. An additional effect noticeable in the case of a Helmholtz cavity where the orifice is a part of the cavity construction is that the cavity is detuned from the drive frequency when the orifice is partially obstructed. This also creates an acoustic impedance mismatch and affects the pressure levels within the cavity.

This substantial change in the quantity of energy coupled from the transducer and transmitted out of the alarm can be detected by sensing a change in the electrical parameters of the transducer as seen by the driving system. Consequently, this obstruction of the sound exit can be used as an indication that the operator has acknowledged the sound by manually obstructing the sound emitting orifice.

The manner of sensing the change in the electrical parameters can be understood by recognizing that the electrical equivalent circuit of a piezoelectric transducer is an electrical impedance that is an electrical representation of both the electrical and mechanical properties of the transducer. The energy storage represented by the resonant inductance and capacitance actually is mostly energy stored in the mechanical oscillation of the bender. The equivalent circuit resistance represents the sum of the mechanical friction losses, heating of the transducer and principally the energy transferred to the sound waves. When the air passage is obstructed the mechanical resonance properties, i.e. the acoustic impedance, of the Helmholtz cavity changes and this change is reflected into a change in the mechanical oscillatory properties of the crystal bender coupled to the cavity. The changes in the mechanical oscillatory properties of the bender are reflected as changes in the electrical impedance properties of the transducer observed at the transducer terminals.

There are many ways of detecting this change in the transducer equivalent circuit impedance depending on the drive circuit and measurement parameter. However, generally the change in the equivalent electrical impedance of the transducer results in changes in the currents, voltages and phase in the transducer and the drive circuit. Therefore, sensing a change in a voltage, current or phase in the transducer or drive circuit beyond a selected threshold will sense an obstruction of the orifice. Because the equivalent impedance of the transducer has both a resistive (real) component and a reactive component, the impedance change of its equivalent circuit results in changes of both amplitude and phase.

The quantity of change and selection of the threshold value to distinguish an acknowledgement by an operator from unobstructed normal operation and noise is most conveniently determined by testing an alarm unit by measuring the current, voltage and/or phase both under normal operating conditions and while an obstruction approaches the orifice. FIG. 6 illustrates an obstruction, in the form of a human finger 100, moving into the path of the sound wave 101 being emitted from an orifice 103 in a case 102. As the obstruction nears the orifice, the impedance of the transducer and therefore the voltage, current and/or phase will begin to change as the operational changes described above begin to occur. The designer can then select a quantity of change that exceeds any changes that occur during normal operation. It is not necessary that the orifice be entirely obstructed but a designer may select that condition for the threshold value if desired. Consequently, the word “obstruction” is used to mean a partial or complete barrier near the orifice that is at least sufficient to cause changes in the alarm that are in excess of the changes encountered in normal operation in the absence of barrier near the orifice.

The change in the sound pressure waves within the chamber can also be detected by means other than the change in a voltage or current in the drive circuit or the transducer. Additional sensors can be utilized to monitor properties of the sound transducer, such as the stresses within the transducer in response to being driven, or to monitor the sound pressures within the sound chamber, either directly or through derived measurements such as measurement of the sound pressure wave of one or more chambers acoustically connected to the transducer.

After orifice blocking, the changed conditions within the sound chamber can also be detected by monitoring a condition of a transducer that is not connected to the drive circuitry, such as an auxiliary terminal on a piezoelectric transducer, or through an auxiliary microphone acoustically connected to the sound chamber. The term “microphone” is used in the generic sense of a transducer for converting mechanical oscillations to electrical oscillations and is not limited to devices designed for audio systems that input a human voice or music. This pickup or microphone will also enable the detection of the operator orifice blockage to signal an alarm acknowledgement.

The sensing of acknowledgment by sensing obstruction of the orifice in a manner described above can initiate a switch function. The audible alarm control and drive circuitry can then perform designated actions such as reducing the sound intensity for a fixed time duration or until the next time power is applied to the audible alarm. Reducing the sound intensity includes reducing it to zero and thereby muting it. The switch function can also be supplied to external or auxiliary circuits or systems.

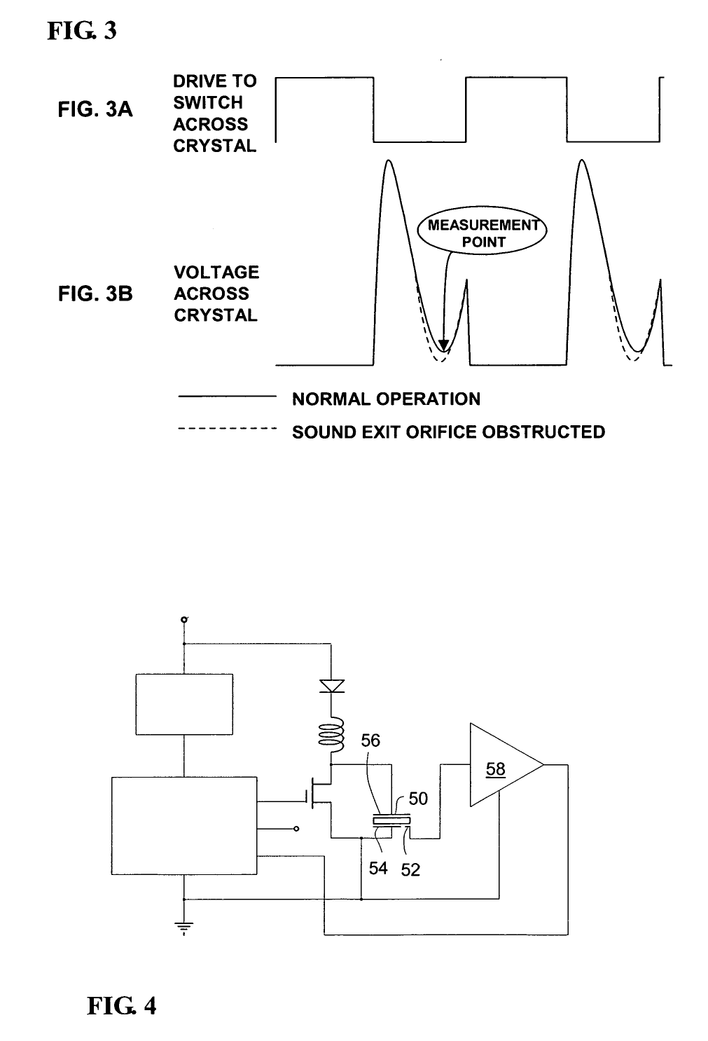

FIG. 2 illustrates an embodiment of the invention having a piezoelectric transducer 30 connected through an inductor 32 and diode 34 to a terminal 36 for connection to a source of DC electrical power. The piezoelectric transducer 30 is mounted in an enclosure or case as illustrated in FIG. 1. A control circuit 38 is also connected, through a power conditioning circuit 40, to the power source terminal 36. The control circuit 38 can be a pulse width modulator having an output connected to and controlling an FET electronic switch 42. When switch 42 is driven with a voltage signal such as shown in FIG. 3A, it causes a current through inductor 32. More specifically, when the switch 42 is turned on, current flows through the inductor 32 and switch 42 storing energy in the magnetic field of the inductor. When the switch 42 is turned off, the inductor current begins flowing through the transducer 30 instead of the switch 42 so that a current pulse is applied to the transducer 30 and the energy stored in the inductor is transferred to the piezoelectric transducer 30 as the series inductor and transducer current decays to essentially zero.

As switch 42 is turned on through the drive signal shown in FIG. 3A, the current through inductor 32 builds and then decays as it is diverted into transducer 30. The solid line oscillogram of FIG. 3B illustrates the voltage across the transducer 30 through this cycle. The current pulse applied to the transducer causes it to mechanically oscillate in an approximate but distorted and damped sinusoidal manner. Because a property of a piezoelectric material is that the voltage across it is an increasing function of its strain, the voltage at its terminal is approximately a damped sinusoid when the switch 42 is turned off as illustrated in FIG. 3B. When the switch 42 is turned on to repeat the cycle, the mechanical oscillation of the transducer continues as a damped oscillation. The circuit and the operation described in the foregoing paragraph is known prior art.

Also known in the prior art is that the control circuit 38 can, alternatively, be a microcontroller or other controller circuit that performs the pulse width modulating function and controls the switch 42 to apply pulses to it as described above.

In addition to the prior art components illustrated in FIG. 2, the circuit also has an amplifier 44 having an input connected to the transducer 30 which is also the output of the transducer drive circuit. The amplifier 44 provides a voltage sensing function capable of sensing the voltage across piezoelectric transducer 30.

If the orifice 4 of the module in FIG. 1 is obstructed, as by a finger, the sound pressure within the cavity changes. Consequently, the resulting alternating component of the voltage across the piezoelectric element 30 in FIG. 2 changes as shown by the dashed line in the bottom portion of the curve of FIG. 3B. This provides a convenient measuring point for sensing a change in the circuit resulting from obstructing the orifice. If the voltage is measured at this voltage minimum, a determination can be made as to whether the system is operating normally (solid line) or the orifice is obstructed (dashed line). The voltage after obstruction of the orifice can be used as the input for sensing that the operator has acknowledged the alarm.

There are more ways than it is practical to describe that these circuit parameter changes can be used to sense a change beyond a selected threshold resulting from obstruction of the orifice. The preferred way is to use a microcontroller as the control circuit 38 and also use it as a comparing circuit to compare a sensed change in the sound pressure wave to a selected threshold. The microcontroller already has a conventional output connected to and controlling the drive circuit switch 42. The amplifier 44 can condition the transducer signal for measurement at a comparator or analog-to-digital input of the microcontroller 38. The microcontroller is programmed to detect and store an initial value, or a set or array of values, representing operation of the alarm when the orifice is unobstructed. The microcontroller 38 is also programmed to store a value of the selected threshold as determined experimentally as described above. The microcontroller 38 is further programmed to compare the sensed voltage to the unobstructed initial value and change an internal state when the difference between the initial unobstructed value or set of values and the sensed voltage or current exceeds the stored threshold value. Since the microcontroller 38 is programmed, for example as done in the prior art, to control the switch 42 and apply the pulse width modulated pulses to the switch 42, the microcontroller can be advantageously also programmed to reduce the power applied to the transducer by reducing the pulse width and/or frequency in response to the change in the internal state resulting from sensing the occurrence of an obstruction at the orifice. This will result in a reduction in the sound intensity from the alarm or the complete muting of the alarm.

Although there are undoubtedly many ways that the microcontroller can be programmed to sense voltage, current or phase changes, the preferred way is to sense changes around the minimum voltage indicated at the measurement point illustrated in FIG. 3B and to do so in the following manner. An inverting amplifier with a DC offset is used as the amplifier 44 and is connected through an A/D converter, such as an analog to digital (A/D) converter provided on board the microcontroller, to allow the microcontroller 38 to obtain a number of voltage values in the vicinity of the transducer minimum shown if FIG. 3B. The transducer voltage is sampled at intervals, such as every 25 microseconds, during the time interval that the switch 42 is turned off. This may, for example, provide 5 samples across this off time interval. When power is first applied to the alarm, an initial set or array of such samples is stored as reference samples based on the assumption that they were taken under a no-alarm condition. Thereafter, subsequent sets or arrays of such samples are periodically taken. Each set of subsequent samples is compared to the set of reference samples to determine if a change beyond a selected threshold has occurred. More specifically, the comparison of the reference samples to a set of subsequent samples begins by computing the difference between corresponding samples, that is the difference between the first reference sample and the first subsequent sample is computed and stored, the difference between the second reference sample and the second subsequent sample is computed and stored and this is repeated until a difference between all corresponding samples is stored. Then the absolute value of these differences is summed. If this sum exceeds the selected threshold value, the microcontroller stores that result as a changed internal state. An advantage of this algorithm for sensing a change beyond a selected threshold is that it senses both changes in the amplitude of the sampled voltage illustrated in FIG. 3B and also senses changes in the phase of that voltage. Sensing a phase change can be important because the above-described changes in the equivalent impedance of the transducer have been seen to also result in phase changes.

Because the microcontroller has multiple outputs, it can also be programmed to have an “auxiliary” output 15 that changes state in response to the change in the internal state caused by a sensed obstruction. This auxiliary output 15 can be used for switching the state of an external or auxiliary circuit. For example, if the alarm indicates a malfunction of some external device, the output can be used to disable, interrupt power to or halt operation of the external device.

It will be recognized by those familiar with the art that the discussion of a microcontroller function will include similar realization of the control function, as by discrete logic, programmable logic array (PLA) or programmable gate array (PGA) implementations, or by microprocessors. Therefore, the term “controller circuit” has been adopted as a term generically including these known types of digital logic control implementations that can be used to control the circuit as an alternative to a microcontroller.

Some examples of alternative ways of detecting the circuit voltage or current changes resulting from obstruction of the orifice include both analog circuitry and other digital circuitry. For example, the transducer voltage can be applied through a DC blocking capacitor and rectifier and the average, peak or rms value of the resulting signal sensed by any of the numerous circuits available in the prior art for sensing those values. A signal representing the sensed value can be applied to a comparator having a reference voltage representing the threshold and the comparator would shift its output state in response to the sensed value exceeding the reference threshold value. Because changes in the impedance of the transducer are reflected as voltage and current changes in other parts of the drive circuit, other parts may be monitored for changes.

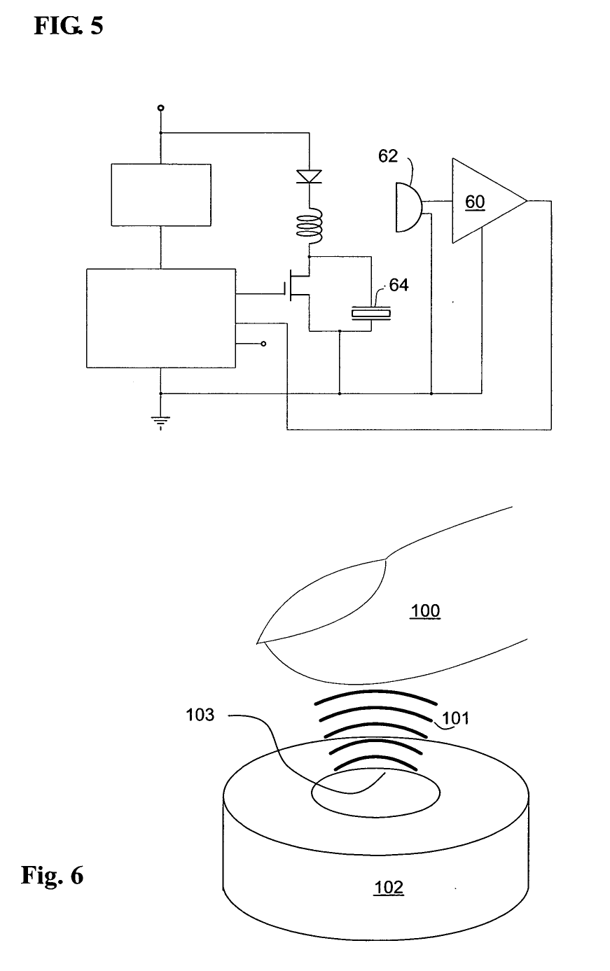

FIGS. 4 and 5 represent examples of other means of determining the modified sound levels present within the sound path caused by the blocking of the sound orifice and which are therefore capable of detecting this blockage as an indication of an alarm acknowledgement.

FIG. 4 illustrates an alternative embodiment which is like FIG. 2 except the piezoelectric crystal 50 includes an additional third terminal 52 unconnected to either drive terminal 54 or 56. This additional terminal 52 has a voltage representing the mechanical stresses within the piezoelectric crystal. Therefore, the voltage at this third terminal 52 represents the mechanical deflection of the transducer and permits the transducer to appear at the third terminal somewhat like a piezoelectric microphone in the chamber. Because the mechanical oscillation of the transducer decays more slowly when the orifice is obstructed, the third terminal can serve as an alternative input to the voltage sensing circuit 58.

FIG. 5 illustrates a circuit that is like the circuit of FIG. 2 except that the input to the amplifier 60 is from a microphone 62 instead of from the transducer 64. The microphone can sense the sound levels in the Helmholtz cavity or the microphone can be mounted on the circuit board 8 in FIG. 1 to measure the sound pressure wave between the circuit board 8 and the piezoelectric element 12. The microphone 62 must be acoustically coupled to the transducer 64 but is not necessarily in communication with the chamber of the alarm. It can even be coupled to sense the mechanical vibrations through solid structures of the alarm.

It will be recognized by those skilled in the art that the driving of other audio transducers, such as a speaker or mechanical buzzer, reflects in a conceptually similar way the conversion of electrical energy into sound energy. The blockage of the sound transmission under operator control can be detected by a change in the drive or a change in the sound pressure within such an audio alarm. These changes then can be sensed to allow the blockage of the sound transmission to be interpreted as an alarm acknowledgement to mute the alarm and/or function as a switch closure.

It will be recognized by those skilled in the art that while the preceding discussion uses the obstruction of the sound path as an acknowledgement by an operator of the audible alarm, the switch function can be the primary use of such a device. The sensitivity of such a device can allow the detection from the back pressure of objects near the sound exit orifice of a Helmholtz cavity allowing such a device to be used as a non-contact proximity detector. When used in such an application the frequency of the sound need not be within that of human hearing.

The devices described above can be used as switches regardless of whether they also emit a sound within the frequency range that can be perceived by humans. The transducer can be continuously energized to emit a sound wave, so it is operating in the same manner as described above when an alarm condition has been sensed. The switched output is the output described for switching an auxiliary device. Then, when an obstruction occurs, the switch output will still operate as described above to switch an auxiliary device. Operated in this manner, the device is a proximity switch. Although operation as a proximity switch while driving the transducer at a frequency with the frequency range of human hearing might be annoying, the device can be operated at frequencies outside that range to avoid the annoyance.

Additionally, it has been discovered during experiments with laboratory models constructed according to the invention that air disturbances, such as directing a stream of air past the orifice, have the same effect as holding an obstructing body close to the orifice. Therefore, a device constructed in accordance with the invention can be used to detect the presence of a gas or fluid stream.

While certain preferred embodiments of the present invention have been disclosed in detail, it is to be understood that various modifications may be adopted without departing from the spirit of the invention or scope of the following claims.

1. A method for sensing obstruction of a sound emitting orifice of a surrounding case having at least one sound emitting orifice connected in acoustic communication to a chamber of an acoustic impedance-matching network, an electromechanical sound transducer in acoustic communication with the chamber and an electronic drive circuit for driving the transducer, the method comprising:
sensing a change beyond a selected threshold of the sound pressure wave in the chamber caused by obstruction of the orifice.

2. A method in accordance with claim 1 wherein the amplitude of the sound pressure wave is sensed.

3. A method in accordance with claim 1 wherein the phase of the sound pressure wave with respect to a drive signal applied by the drive circuit is sensed.

4. A method in accordance with claim 1 and more particularly comprising sensing a change beyond a selected threshold of the sound pressure wave by directly sensing the sound pressure wave, converting the sound pressure wave to an electrical signal and changing the electrical state of a circuit in response to a sound pressure amplitude or phase change beyond the selected threshold.

5. A method in accordance with claim 4 where the sound pressure wave is directly sensed by a microphone acoustically coupled to the chamber or transducer.

6. A method in accordance with claim 4 wherein the sound pressure wave is sensed by sensing the voltage of a third terminal on the transducer.

7. A method in accordance with claim 1 and more particularly comprising sensing the change of the sound pressure wave by sensing a change in a voltage or current in the drive circuit of the transducer resulting from a change of an electrical impedance property of the transducer.

8. A method in accordance with claim 1 or 2 or 3 or 4 or 5 or 6 or 7 and further comprising changing the electrical state of a circuit in response to a sound pressure wave change beyond the selected threshold and applying a signal, resulting from said electrical state change, to an associated circuit for effecting a change in the associated circuit.

9. A method in accordance with claim 1 or 2 or 3 or 4 or 5 or 6 or 7 wherein the transducer vibrates at a frequency within the range of human perception to provide an audible alarm.

10. A method in accordance with claim 9 and further comprising applying a signal, resulting from said obstruction, to the electronic drive circuit to reduce the power applied by the drive circuit to the transducer.

11. An improved audible alarm including a surrounding case enclosing a chamber of an acoustic impedance-matching network and having at least one externally opening, sound exiting orifice connected in acoustic communication with the chamber, an electromechanical sound transducer connected in acoustic communication with the chamber for generating a sound pressure wave and an electronic drive circuit for driving the transducer, wherein the improvement senses operator obstruction of the orifice and comprises:
(a) an electronic sensing circuit connected to sense changes in the sound pressure wave in response to obstruction of the orifice; and
(b) a comparing circuit connected to an output of the sensing circuit for comparing a sensed change in the sound pressure wave to a selected threshold, the comparing circuit having an output that changes state in response to a sensed change exceeding the threshold.

12. An audible alarm in accordance with claim 11 wherein the sensing circuit has an input connected to the drive circuit or the transducer for sensing a voltage or current change resulting from a change in the impedance of the transducer caused by obstruction of the orifice.

13. An audible alarm in accordance with claim 11 wherein the sensing circuit comprises a microphone acoustically coupled to the chamber or transducer.

14. An audible alarm in accordance with claim 11 wherein the sensing circuit comprises a third terminal on the transducer.

15. An audible alarm in accordance with claim 11 or 12 or 13 or 14 and further comprising a controller circuit having an output connected to and controlling the drive circuit, wherein the sensing circuit has an output connected to the controller circuit and the controller circuit is programmed to store a value representing operation of the alarm when the orifice is unobstructed, to store a value of the selected threshold and to compare the sensed voltage or current to the unobstructed value and change an internal state when the sensed voltage or current exceeds the stored threshold value.

16. An audible alarm in accordance with claim 15 wherein the transducer is a piezoelectric transducer including a bender diaphragm.

17. An audible alarm in accordance with claim 16 wherein the controller circuit is programmed to reduce the power applied to the transducer in response to said change in said internal state.

18. An audible alarm in accordance with claim 16 wherein the controller circuit has an output that changes state in response to said change in said internal state for switching the state of an auxiliary circuit.

19. An audible alarm in accordance with claim 16, wherein an inductor is connected between a source of electrical power and the transducer, an electronic switch is connected to the transducer for applying electrical pulses to the transducer, the electronic switch having an input connected to a controller circuit for controlling and switching the electronic switch and wherein the output of the sensing circuit is connected to an input of the controller circuit and the controller circuit is programmed to reduce the power applied to the transducer in response to said change in said internal state. upon detection of said obstruction.

20. An audible alarm in accordance with claim 19 wherein the controller circuit is programmed to reduce power to the transducer by means of changes to the frequency or pulse width of electrical pulses to the transducer.

21. An audible alarm in accordance with claim 19 wherein the controller circuit has an output that changes state in response to said change in said internal state for switching the state of an auxiliary circuit.

22. An electronic switch that switches in response to an object in proximity to a sensing region contiguous to the switch or a gas or fluid stream directed through the sensing region, the electronic switch comprising:
(a) a case surrounding a chamber of an acoustic impedance-matching network and having at least one externally opening, sound exiting orifice connected in acoustic communication with the chamber, the sensing region being external of the case and contiguous to the orifice;
(b) an electromechanical sound transducer connected in acoustic communication with the chamber for generating a sound pressure wave;
(c) an electronic drive circuit for driving the transducer;
(c) an electronic sensing circuit connected to sense changes in the sound pressure wave in response to obstruction of the orifice or a gas or fluid stream disturbance in the sensing region; and
(d) a comparing circuit connected to an output of the sensing circuit for comparing a sensed change in the sound pressure wave to a selected threshold, the comparing circuit having an output that changes state in response to a sensed change exceeding the threshold.

23. A switch in accordance with claim 22 wherein the sound is above the frequency range perceived by humans.

24. An audible alarm in accordance with claim 22 wherein the sensing circuit has an input connected to the drive circuit or the transducer for sensing a voltage or current change resulting from a change in the impedance of the transducer caused by obstruction of the orifice.

25. An audible alarm in accordance with claim 22 wherein the sensing circuit comprises a microphone acoustically coupled to the chamber or transducer.

26. An audible alarm in accordance with claim 22 wherein the sensing circuit comprises a third terminal on the transducer.

27. An audible alarm in accordance with claim 23 or 24 or 25 or 26 and further comprising a controller circuit having an output connected to and controlling the drive circuit, wherein the sensing circuit has an output connected to the controller circuit and the controller circuit is programmed to store a value representing operation of the alarm when the orifice is unobstructed, to store a value of the selected threshold and to compare the sensed voltage or current to the unobstructed value and change an internal state when the sensed voltage or current exceeds the stored threshold value.

28. An audible alarm in accordance with claim 27 wherein the transducer is a piezoelectric transducer including a bender diaphragm.

29. An audible alarm in accordance with claim 27 wherein the controller circuit is programmed to reduce the power applied to the transducer in response to said change in said internal state.

30. An audible alarm in accordance with claim 27 wherein the controller circuit has an output that changes state in response to said change in said internal state for switching the state of an auxiliary circuit.

31. An audible alarm in accordance with claim 27, wherein an inductor is connected between a source of electrical power and the transducer, an electronic switch is connected to the transducer for applying electrical pulses to the transducer, the electronic switch having an input connected to a controller circuit for controlling and switching the electronic switch and wherein the output of the sensing circuit is connected to an input of the controller circuit and the controller circuit is programmed to reduce the power applied to the transducer in response to said change in said internal state upon detection of said obstruction.

32. An audible alarm in accordance with claim 31 wherein the controller circuit is programmed to reduce power to the transducer by means of changes to the frequency or pulse width of electrical pulses to the transducer.

33. An audible alarm in accordance with claim 31 wherein the controller circuit has an output that changes state in response to said change in said internal state for switching the state of an auxiliary circuit.
